(19) United States
(12) Patent Application Publication
(10) Pub. No.: US 2008/0224824 A1
(43) Pub. Date: Sep. 18, 2008

(54) Keyless Entry System

(75) Inventor: Akihiro YOSHIZAWA, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 12/049,146

(22) Filed: Mar. 14, 2008

(30) Foreign Application Priority Data
Mar. 15, 2007 (JP) 2007-067001

(51) Int. Cl. G08B 29/00

(52) U.S. Cl. 340/5.61

(57) ABSTRACT

A keyless entry system that prevents a steering shaft and such from being unlocked without any intention of a passenger. A portable device is carried by a passenger and a vehicle control device for carrying out a certification process for the portable device to lock or unlock a device subject to locking is mounted to a vehicle. The portable device sends instruction information giving an instruction to limit unlocking of the device subject to locking to the vehicle control device in accordance with an instruction from the passenger. The vehicle control device maintains locking of the device subject to locking in the case of receiving the instruction information from the portable device.

### RELATED APPLICATIONS

This application claims the benefit of priority under 35 USC 119 of Japanese patent application no. 2007-067001, filed on Mar. 15, 2007, which application is hereby incorporated by reference in its entirety.

### BACKGROUND OF THE INVENTION

1. Field of the Invention

The invention relates to a technology of limiting unlocking of a device subject to control such as an engine and a steering unit in a keyless entry system of a straddle-type vehicle.

2. Description of Related Art

Recently, in straddle-type vehicles such as motorcycles, keyless entry systems have been provided to start an engine without insertion of a key into a key cylinder. Such keyless entry systems include a portable device carried by a passenger that holds preset identification information and a vehicle control device mounted to a vehicle for locking/unlocking a steering unit or limiting/allowing start of an engine.

In such a keyless entry system, the passenger typically carries out a predetermined switching operation after the portable device approaches the vehicle and enters a communication area. The vehicle control device then receives identification information from the portable device and executes a certification process for the portable device on the basis of the identification information. The vehicle control device releases locking of a steering unit or allows an engine to start when the portable device is judged to be a proper device registered in the vehicle control device in advance.

In such a keyless entry system, however, there is a possibility of unlocking of the steering unit and such without any intention of a passenger. For example, the certification process for the portable device may be performed to unlock the steering unit when the portable device is in the communication area and a person other than the passenger carries out the predetermined switching operation even in the case that the passenger is carrying out some work or the like in the neighborhood of the vehicle without intention of unlocking of the steering unit.

In order to prevent such a case, a keyless entry system has been proposed in which a switch for stopping the communication function with the vehicle control device is provided in the portable device (JP-A-2005-104197). In this system, no identification information is sent from the portable device to the vehicle control device when the passenger stops the communication function through the switching operation of the portable device. Accordingly, no certification process for the portable device is carried out. This prevents unlocking of the steering unit by a person other than the passenger without any intention of the passenger.

In the keyless entry system of JP-A-2005-104197, however, convenience is reduced since the communication function of the portable device is stopped for the purpose of preventing the steering unit from being unlocked without the intention of the passenger. In some keyless entry systems, for example, in order to reveal the location of the vehicle in a dimly-lit place, the passenger carries out the switching operation to cause the portable device to send the vehicle a signal indicating the predetermined switching operation to turn on a light of the vehicle. In the keyless entry system of JP-A-2005-104197, however, the passenger cannot use this function when the communication function of the portable device is stopped.

### SUMMARY OF THE INVENTION

The invention addresses these problems and provides a keyless entry system with improved convenience in which unlocking of a device subject to control such as an engine and a steering unit is prevented without intention of the passenger.

A keyless entry system in accordance with the invention includes a portable device carried by a passenger and a vehicle control device mounted to a vehicle for carrying out a certification process for the portable device to lock or unlock a device subject to locking, on the basis of a result of the certification process. The portable device includes an input device for receiving an instruction from the passenger and sends instruction information for giving an instruction to limit unlocking of the device subject to locking to the vehicle control device in accordance with the instruction received from the passenger by means of the input device while the vehicle control device maintains locking of the device subject to locking in the case of receiving the instruction information from the portable device.

In accordance with the invention, locking of a device of a vehicle subject to locking, can be maintained in accordance with an instruction from a passenger without stopping the communication function of the portable device. Therefore, convenience of the keyless entry system is improved.

In one aspect of the invention, the portable device sends identification information inherent in the portable device together with the instruction information and the vehicle control device carries out the certification process on the basis of the identification information of the portable device. The vehicle control device can thereby identify the portable device that has sent the instruction information.

In another aspect of the invention, the portable device further includes a storing device for storing instruction receive information indicating that the input device has received an instruction to limit unlocking of the device subject to locking from a passenger. The vehicle control device sends demand information demanding a response from the portable device and the portable device sends the instruction information to the vehicle control device in the case of receiving the demand information from the vehicle control device while the storing device holds the instruction receive information. In accordance with this aspect of the invention, the portable device can inform the vehicle control device that an instruction to limit unlocking of the device subject to control has been received when the demand information is sent from the vehicle control device.

The portable device may further include an information device for informing a passenger that the storing device stores the instruction receive information. This allows the passenger carrying the portable device to be informed of an instruction to limit unlocking of the device subject to control even after the passenger gave the instruction.

In another aspect of the invention, the portable device sends and receives condition information related to a condition of the portable device or a vehicle to and from the vehicle control device. In accordance with this aspect, convenience of the keyless entry system is improved. Moreover, the portable device may further include a battery remaining quantity detection circuit for detecting remaining quantity of a battery used as a driving source of the portable device and send information related to the battery remaining quantity as the condition information.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a side view of a motorcycle having a keyless entry system according to an embodiment of the invention.

FIG. 2 is a block diagram of the keyless entry system and a vehicle control device.

FIG. 3 is a block diagram of a portable device of the keyless entry system.

FIG. 4 is a functional block diagram of a control part of the portable device.

FIG. 5 is a functional block diagram of a control part of the vehicle control device.

FIG. 6 is a sequence diagram of a process executed by the vehicle control device and the portable device of the keyless entry system.

### DETAILED DESCRIPTION OF THE INVENTION

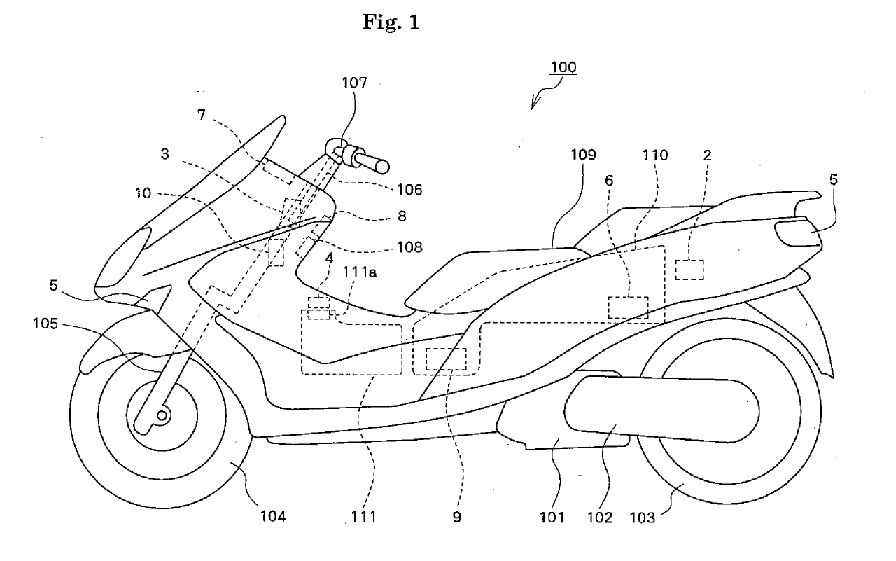

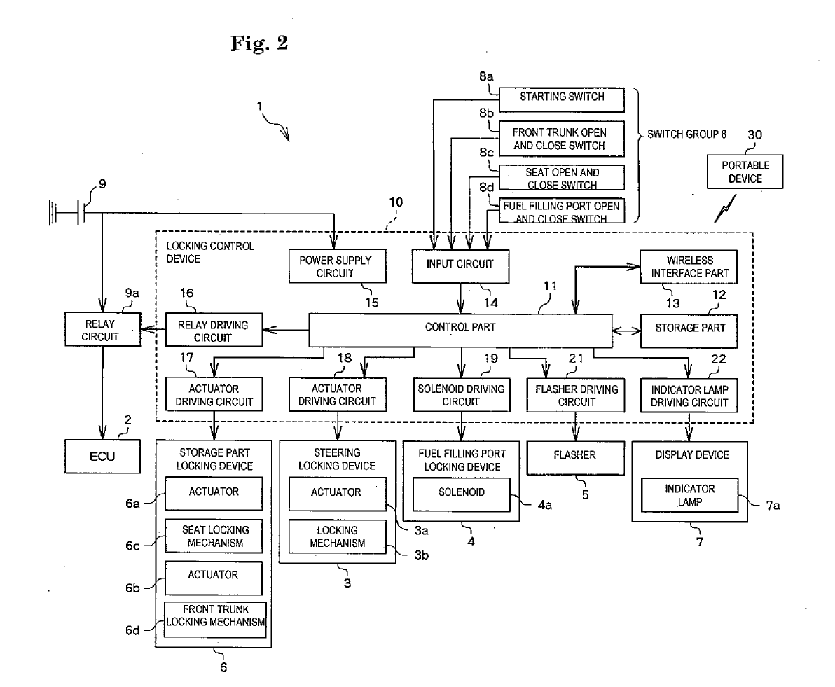

An embodiment of the invention is now described with reference to the drawings. FIG. 1 is a side view of a motorcycle 100 comprising a keyless entry system 1 according to an embodiment of the invention. FIG. 2 is a block diagram of keyless entry system 1 and a vehicle control device 10 included in keyless entry system 1 and mounted to motorcycle 100.

As shown in FIG. 2, keyless entry system 1 includes a portable device 30 carried by a passenger apart from vehicle control device 10. Motorcycle 100 comprises an engine control unit (ECU) 2, a steering locking device 3, a fuel filling port locking device 4, a flasher 5, a storage part locking device 6, a display device 7, a switch group 8, a battery 9 and vehicle control device 10.

ECU 2 includes a read only memory (ROM) and a random access memory (RAM) to control an engine 101 in accordance with a program stored in the ROM or RAM. ECU 2 controls ignition timing of engine 101 and the quantity of fuel supplied to engine 101 and starts engine 101. Vehicle control device 10 is controlled to supply ECU 2 with power from battery 9 to allow operation of ECU 2. Driving force of engine 101 is transmitted to a rear wheel 103 through a driving force transmitting mechanism 102 including a belt and a transmission.

A front wheel 104 is supported on a lower end part of a front fork 105. A steering shaft 106 that transmits a handle operation by a passenger to front wheel 104 is provided on the upper part of front fork 105. Steering locking device 3 is provided adjacently to steering shaft 106. Steering locking device 3 includes a locking mechanism 3b receiving power to operate from an actuator 3a (FIG. 2). Actuator 3a operates by power supplied from vehicle control device 10 to lock steering shaft 106 with locking mechanism 3b so that steering shaft 106 cannot rotate, or to release the locking with locking mechanism 3b.

A handle 107 is provided in the upper part of steering shaft 106. A display device 7, including a digitally displayed speed meter, a tachometer and the like, is provided on the front side of handle 107. Display device 7 also comprises an indicator lamp 7a, such as a light emitting diode (LED), that is turned on by power supplied from vehicle control device 10 apart from the meters of display device 7. Indicator lamp 7a informs a passenger of a condition of portable device 30 or motorcycle 100. Indicator lamp 7a turns on, for example, when the battery remaining quantity of portable device 30 is reduced.

A front trunk 108 capable of opening and closing is provided on the rear side of steering shaft 106. Front trunk 108 opens toward a passenger (to a side where a passenger rides) in the example. A seat 109 that opens and closes is arranged above engine 101. A trunk 110 is provided under seat 109. A storage part locking device 6 is also provided under seat 109 adjacently to trunk 110.

Storage part locking device 6 locks or unlocks a storage part that opens and closes for the purpose of storing a variety of objects. Storage part locking device 6 comprises actuators 6a and 6b, a seat locking mechanism 6c receiving power to operate from actuator 6a and a front trunk locking mechanism 6d receiving power to operate from actuator 6b (FIG. 2). Actuator 6a operates by power supplied from vehicle control device 10 to lock and unlock seat 109 with seat locking mechanism 6c. Actuator 6b operates by power supplied from vehicle control device 10 to lock and unlock front trunk 108 with front trunk locking mechanism 6d. Storage part locking device 6 locks and unlocks front trunk 108 and seat 109 through a wire connecting front trunk 108 and seat 109 to storage part locking device 6.

An upper part of a fuel tank 111 on the front side of seat 109 has a fuel filling port 111a. Fuel filling port locking device 4 is provided adjacently to fuel filling port 111a and includes a solenoid 4a (FIG. 2). Solenoid 4a operates by power supplied from vehicle control device 10 to lock and unlock a lid of fuel filling port 111a.

Flashers 5 are mounted to front and rear parts of the vehicle body to flash on and off in accordance with a switching operation by a passenger to indicate an intended travel direction of motorcycle 100. Flasher 5 also turns on by power supplied from vehicle control device 10 to show a passenger a parking location of motorcycle 100.

A switch group 8 comprising plural switches is provided under handle 107. Switch group 8 includes a starting switch 8a, a front trunk open and close switch 8b, a seat open and close switch 8c and a fuel filling port open and close switch 8d. Each of switches 8a-8d inputs a signal according to a switching operation by a passenger into vehicle control device 10.

Battery 9 provided in seat 109 is connected to and supplies vehicle control device 10 and ECU 2 with power. A relay circuit 9a provided between ECU 2 and battery 9operates in accordance with a signal inputted from vehicle control device 10 to start and stop power supply to ECU 2. ECU 2 is supplied with power from battery 9 when relay circuit 9a is on. This allows ECU 2 to operate.

Vehicle control device 10 executes a certification process for portable device 30 to lock or unlock a device mounted on the vehicle and subject to control (referred to hereinafter as a device subject to locking). In this description, locking a device means limiting operation of the device, and unlocking a device means allowing operation of the device. In this description, ECU 2, steering shaft 106, fuel filling port 111a, seat 109 and front trunk 108 are devices subject to locking, which are locked and unlocked by vehicle control device 10. ECU 2, for example, is allowed to operate when power of battery 9 is supplied while operation of ECU 2 is limited when the power supply is stopped. As for steering shaft 106, locking mechanism 3b of steering locking device 3 allows or limits rotation of steering shaft 106.

Vehicle control device 10 and portable device 30 are now described. Vehicle control device 10 is first described with reference to FIG. 2. Vehicle control device 10 includes a control part 11, a storage part 12, a wireless interface part 13, an input circuit 14, a power supply circuit 15, a relay driving circuit 16, actuator driving circuits 17 and 18, a solenoid driving circuit 19, a flasher driving circuit 21 and an indicator lamp driving circuit 22.

Storage part 12 includes a ROM and a RAM and holds a program executed by control part 11. Storage part 12 also holds identification information preset in portable device 30. Identification information may be provided for plural portable devices. The identification information may be independently set for each portable device in a manufacturing stage, for example. The identification information is used in the process of certification of portable device 30 executed by control part 11.

Control part 11 Includes a central processing unit (CPU) and executes a program held in storage part 12 to control vehicle control device 10. The process executed in control part 11 is described later in detail.

Wireless interface part 13 includes a radio communication antenna. Wireless interface part 13 converts and amplifies a digital signal inputted from control part 11 to a radio wave signal to be sent, and converts and amplifies a radio wave signal received from portable device 30 into a digital signal to be output to control part 11. Wireless interface part 13 sends and receives information demanding that identification information should be sent, information giving an instruction to limit unlocking of the device subject to locking, condition information indicating a condition of portable device 30 or motorcycle 100 and the like to and from portable device 30 in accordance with an instruction from control part 11.

Input circuit 14 is connected to the switches included in switch group 8. Input circuit 14 converts an analog signal inputted from each switch into a digital signal and inputs the converted signal to control part 11.

Power supply circuit 15 converts power supplied from battery 9 into operation voltage for the parts forming vehicle control device 10. Connection lines connecting power supply circuit 15 and the various parts are omitted from FIG. 2.

Relay driving circuit 16 is connected to relay circuit 9a and controls an electric signal supplied to relay circuit 9a on the basis of a signal inputted from control part 11 to set relay circuit 9a at an on or off condition. Actuator driving circuit 17 is connected to storage part locking device 6 and supplies actuators 6a and 6b with driving power in accordance with a signal inputted from control part 11. Actuator driving circuit 18 is connected to steering locking device 3 and supplies actuator 3a with driving power in accordance with a signal inputted from control part 11. Solenoid driving circuit 19 is connected to fuel filling port locking device 4 and supplies solenoid 4a with driving power in accordance with a signal inputted from control part 11 to lock or unlock the lid of fuel filling port 111a. Flasher driving circuit 21 is connected to flasher 5 and supplies flasher 5 with power in accordance with a signal inputted from control part 11 to flash flasher 5 on and off. Indicator lamp driving circuit 22 is connected to display device 7 and supplies indicator lamp 7a of display device 7 with power in accordance with a signal inputted from control part 11 to turn indicator lamp 7a on and off.

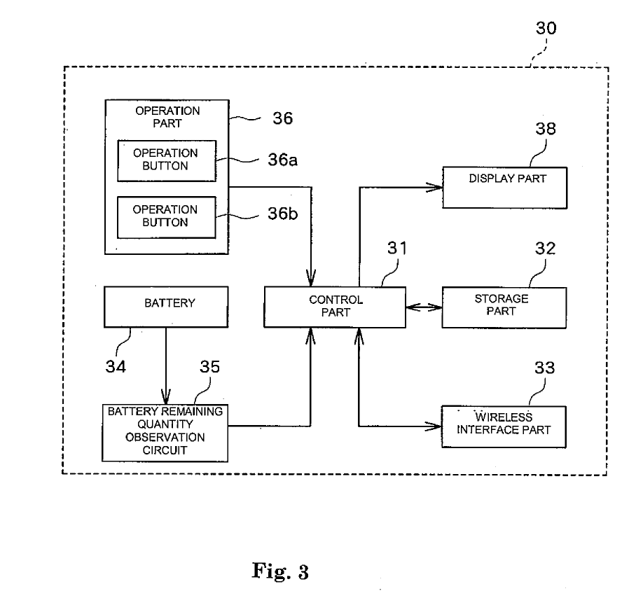

Portable device 30 is now described. FIG. 3 is a block diagram of portable device 30. Portable device 30 includes a control part 31, a storage part 32, a wireless interface part 33, a battery 34, a battery remaining quantity observation circuit 35, an operation part 36 and a display part 38.

Storage part 32 includes a ROM and a RAM and holds a program executed by control part 31. Storage part 32 also holds identification information independently determined in a manufacturing stage of portable device 30 or the like.

Control part 31 includes a CPU and executes a program held in storage part 32 to control portable device 30. The process executed by control part 31 is described later in detail.

Wireless interface part 33 includes a radio communication antenna. Wireless interface part 33 converts and amplifies a digital signal inputted from control part 31 to a radio wave signal to be sent, and converts and amplifies a radio wave signal received from vehicle control device 10 into a digital signal to be output to control part 31. Wireless interface part 33 sends identification information of portable device 30, information giving an instruction to limit unlocking of a device subject to locking by vehicle control device 10, information indicating a remaining quantity of battery 34 and the like, and receives information demanding that identification information be sent, in accordance with an instruction from control part 31.

Battery 34 is a small-sized secondary or primary battery or the like, for example, and supplies parts of portable device 30 with operating power. Connection lines connecting battery 34 with parts of portable device 30 are omitted from FIG. 3.

Battery remaining quantity observation circuit 35 is connected to and observes the output voltage of battery 34, for example, to judge that little battery quantity remains when the voltage outputted from battery 34 is below a predetermined threshold value, and inputs a signal indicating this fact to control part 31.

Operation part 36 includes operation buttons 36a and 36b and inputs a signal according to operation of buttons 36a and 36b by a passenger into control part 11. In particular, operation part 36 receives instructions to limit unlocking of devices subject to locking (ECU 2, steering shaft 106, fuel filling port 111a, seat 109 and front trunk 108) and inputs a signal according to the instruction into control part 11. The signal inputted from operation part 36 is converted into a digital signal by an analog-digital conversion circuit and is then inputted into control part 11.

Display part 38 includes an LED, for example, that is turned on and off in accordance with a signal inputted from control part 31.

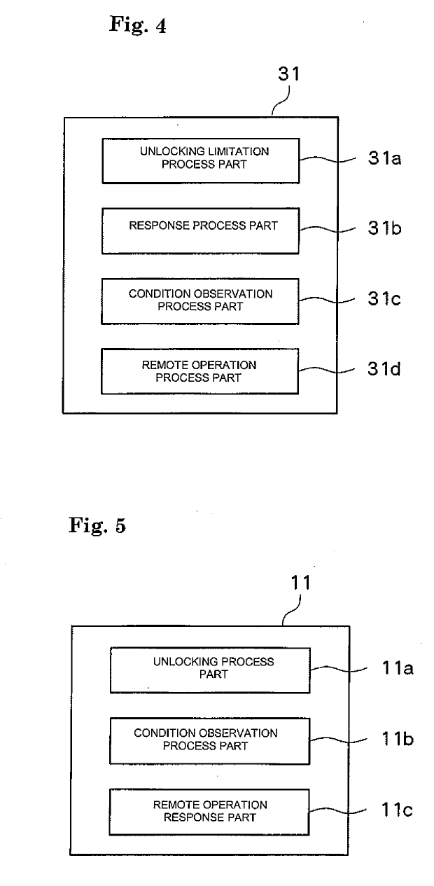

Processes executed by control part 11 of vehicle control device 10 and by control part 31 of portable device 30 are now described. The process executed by control part 31 is first described. FIG. 4 is a functional block diagram of control part 31. Control part 31 functionally includes an unlocking limitation process part 31a, a response process part 31b, a condition observation process part 31c and a remote operation process part 31d.

Unlocking limitation process part 31a stores information that operation part 36 has received an instruction to limit unlocking of a device subject to locking (“instruction receive information”) in storage part 32 when operation part 36 receives such an instruction. Unlocking limitation process part 31a removes the instruction receive information from storage part 32 when operation part 36 receives an instruction to release the limitation of unlocking. Unlocking limitation process part 31a turns display part 38 on in a predetermined mode to inform the passenger that instruction receive information is stored in storage part 32.

Response process part 31b executes a process for meeting a demand of a response when wireless interface part 33 receives from vehicle control device 10 information demanding a response. For example, response process part 31b sends identification information stored in storage part 32 when wireless interface part 33 receives information of a demand to send identification information (“response demand information”).

Response process part 31b also sends to vehicle control device 10 information demanded by vehicle control device 10 (identification information) as well as information indicating an instruction to limit unlocking of a device subject to locking (“unlocking limitation instruction information”) in the case of storing instruction receive information in storing part 32. The process is executed as follows, for example.

Response process part 31b judges whether instruction receive information is stored in storage part 32 when wireless interface part 33 receives from vehicle control device 10 information of a demand of a response. When instruction receive information is stored, response process part 31b sends the information demanded by vehicle control device 10 as well as the unlocking limitation instruction information. Vehicle control device 10 sends the response demand information to portable device 30 whenever a passenger turns on starting switch 8a, front trunk open and close switch 8b, seat open and close switch 8c, fuel filling port open and close switch 8d or the like.

Condition observation process part 31c observes a condition of portable device 30. Condition observation process part 31c sends condition information indicating the condition to vehicle control device 10 through wireless interface part 33 whether or not unlocking limitation instruction information is stored in storage part 32. Condition information in this context, for example, is information related to the remaining quantity of battery 34 (“battery remaining quantity information”). In this case, condition observation process part 31c observes the remaining quantity of the battery on the basis of a signal inputted from battery remaining quantity observation circuit 35. When the battery remaining quantity is below a predetermined threshold value, condition observation process part 31c sends information of this fact to vehicle control device 10 as the battery remaining quantity information.

Furthermore, condition observation process part 31c may send condition information related to a condition of portable device 30 (battery remaining quantity information, for example) to vehicle control device 10 in response to a demand to send condition information in the case of receiving information of the demand from vehicle control device 10.

Moreover, condition observation process part 31c may send unlocking limitation instruction information together with condition information in accordance with whether or not storage part 32 holds instruction receive information in the case of sending condition information related to a condition of portable device 30. Concretely, condition observation process part 31c judges whether instruction receive information is stored in storage part 32 in sending condition information to vehicle control device 10. When instruction receive information is stored, the unlocking limitation instruction information is sent together with the condition information demanded by vehicle control device 10. In this case, vehicle control device 10 may inform a passenger of contents indicated by the condition information after releasing the limitation of unlocking of the device subject to locking. The process carried out by vehicle control device 10 is described later.

In addition, condition observation process part 31c may observe a condition of motorcycle 100 on the basis of information sent from vehicle control device 10. The process is executed as follows, for example.

Vehicle control device 10 demands that portable device 30 should send identification information whenever starting switch 8a, front trunk open and close switch 8b, seat open and close switch 8c or the like is successively turned on. When vehicle control device 10 receives identification information as well as unlocking limitation instruction information from response process part 31b for a number of times predetermined in unit time (more than ten seconds, for example), information indicating this fact (“theft alarm information”) is sent to portable device 30. Condition observation process part 31c of portable device 30, which receives the theft alarm information, judges that there is a possibility of theft of motorcycle 100 and turns on display part 38 in a predetermined mode (flickering, for example) to inform a passenger of this possibility.

Remote operation process part 31d sends information indicating contents of remote operation of motorcycle 100 (“remote operation information”) when a passenger carries out a predetermined button operation to input a signal instructing remote operation through operation part 36. Remote operation information, for example, may give an instruction to turn on flasher 5 to reveal the location of motorcycle 100 in a dimly-lit place or may give an instruction to unlock seat 109.

Further, remote operation process part 31d may send unlocking limitation instruction information in addition to remote operation information based on whether instruction receive information is stored in storage part 32. That is, remote operation process part 31d judges whether instruction receive information is stored in storage part 32 in sending remote operation information. When instruction receive information is stored, it may be sent to vehicle control device 10 together with the remote operation information.

When instruction receive information is stored in storage part 32, remote operation process part 31d may uniformly send the remote operation information and the unlocking limitation instruction information, or may send the unlocking limitation instruction information together with the remote operation information in accordance with the contents of an instruction in the remote operation information. For example, the unlocking limitation instruction information may be sent together with the remote operation information when the remote operation information gives an instruction to unlock seat 109, while the remote operation information be sent without the unlocking limitation instruction information regardless of whether the instruction receive information is stored in storage part 32 when the remote operation information gives an instruction to turn on flasher 5.

A process executed by control part 11 of vehicle control device 10 is now described. FIG. 5 is a functional block diagram of control part 11. Control part 11 functionally includes an unlocking process part 11a, a condition observation process part 11b and a remote operation response part 11c.

Unlocking process part 11a executes a certification process for portable device 30 to carry out a process for unlocking the device subject to locking on the basis of a result of the certification process and whether or not the unlocking limitation instruction information is received from portable device 30. The process in unlocking process part 11a is executed as follows, for example.

Unlocking process part 11a first sends response demand information of a demand to send identification information whenever a passenger turns on starting switch 8a, front trunk open and close switch 8b, seat open and close switch 8c, fuel filling port open and close switch 8d or the like. Unlocking process part 11a executes the certification process on the basis of identification information that is received from portable device 30. Concretely, unlocking process part 11a judges whether the identification information stored in storage part 12 accords with the identification information received from portable device 30. Portable device 30 is judged to be a proper portable device registered in advance in the case of accordance.

Unlocking process part 11a also judges whether unlocking limitation instruction information is attached to the identification information received from portable device 30. Unlocking process part 11a carries out a process of unlocking the device subject to locking when portable device 30 is recognized as a proper portable device and the received identification information has no unlocking limitation instruction information attached. When starting switch 8a is turned on, for example, a signal giving an instruction to turn on relay circuit 9a is outputted to relay driving circuit 16 while a signal giving an instruction to unlock steering shaft 106 is outputted to actuator driving circuit 18. A signal giving an instruction to unlock front trunk 108 or seat 109 is outputted to actuator driving circuit 17 when seat open and close switch 8c or front trunk open and close switch 8b is turned on. A signal giving an instruction to unlock fuel filling port 111a is outputted to solenoid driving circuit 19 when fuel filling port open and close switch 8d is turned on.

On the other hand, unlocking process part 11a does not output the signal described above to relay driving circuit 16, actuator driving circuit 18 or 17 or solenoid driving circuit 19 when unlocking limitation instruction information is attached to the received identification information. In this case, unlocking process part 11a maintains a locking condition of front trunk 108, seat 109, ECU 2, steering shaft 106 or fuel filling port 111a.

Condition observation process part 11b observes a condition of portable device 30 on the basis of condition information received from portable device 30 to display contents indicated in the condition information on display device 7. When wireless interface part 13 receives battery remaining quantity information indicating that the battery remaining quantity is below a predetermined threshold value from portable device 30, for example, condition observation process part 11b outputs a signal giving an instruction to turn on indicator lamp 7a to indicator lamp driving circuit 22.

When wireless interface part 13 receives condition information as well as unlocking limitation instruction information, condition observation process part 11b may display the contents indicated in the condition information on display device 7 after the limitation of unlocking of the device subject to locking is released without displaying on display device 7 the contents indicated in the condition information in receiving the condition information and the unlocking limitation instruction information as described above. The process is executed as follows, for example.

Condition observation process part 11b stores the condition information in storage part 12 when wireless interface part 13 receives the condition information as well as the unlocking limitation instruction information. After that, in the case that turning on any switch included in switch group 8, for example, causes wireless interface part 13 to receive identification information with no unlocking limitation instruction information and that the certification process on the basis of the identification information results in recognition that portable device 30 is a proper portable device, contents indicating the condition information stored in storage part 12 are displayed on display device 7. When battery remaining quantity information is stored in storage part 12 as condition information, for example, condition observation process part 11b outputs a signal giving an instruction to turn on indicator lamp 7a to indicator lamp driving circuit 22.

Condition observation process part 11b also observes a condition of motorcycle 100 to send information obtained on the basis of a result of the observation to portable device 30. The process is executed as follows, for example.

Unlocking process part 11a sends response demand information of a demand to send identification information to portable device 30 whenever starting switch 8a, front trunk open and close switch 8b, seat open and close switch 8c or the like is successively turned on. Condition observation process part 11b counts a frequency that unlocking limitation instruction information is received from portable device 30 together with identification information. Condition observation process part 11b judges that motorcycle 100 is likely to be stolen when unlocking limitation instruction information is received for a number of times predetermined in unit time, and therefore, sends theft alarm information indicating this fact to portable device 30.

Remote operation response part 11c executes a process for controlling motorcycle 100 on the basis of remote operation information received from portable device 30 and whether unlocking limitation instruction information is attached to the remote operation information. Remote operation response part 11c judges whether unlocking limitation instruction information is attached to remote operation information, for example, when remote operation information giving an instruction to unlock seat 109 by storage part locking device 6 is received from portable device 30. A signal giving an instruction to unlock seat 109 is outputted to actuator driving circuit 17 when no unlocking limitation instruction information is attached. On the other hand, remote operation response part tic does not output the signal described above when unlocking limitation instruction information is attached to the remote operation information. In this case, remote operation response part 11c thus maintains a locking condition of seat 109.

In some cases, remote operation response part 11c may execute a process based on remote operation information in accordance with contents of the remote operation instructed whether or not unlocking limitation instruction information is attached. For example, remote operation response part 11c may output a signal giving an instruction to turn on flasher 5 to flasher driving circuit 21 even when unlocking limitation instruction information is attached to remote operation information giving an instruction to turn on flasher 5.

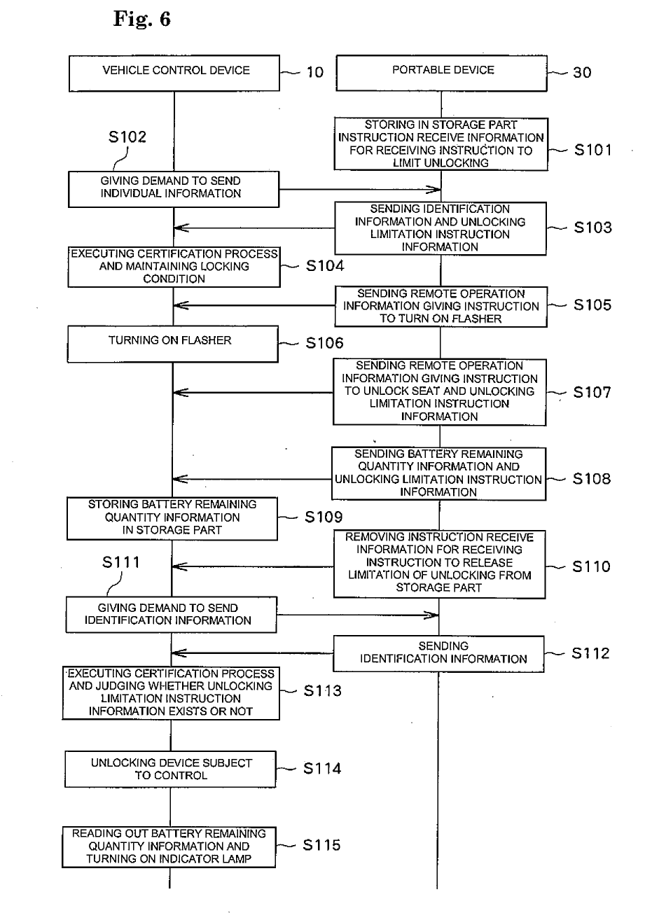

A flow of a process executed by portable device 30 and vehicle control device 10 is now described. FIG. 6 is a sequence diagram showing the process executed by portable device 30 and vehicle control device 10.

In S101, unlocking limitation process part 31a stores instruction receive information in storage part 32 when operation part 36 receives an instruction from a passenger to limit unlocking of a device subject to locking (such as ECU 2, steering shaft 106, fuel filling port 111a, seat 109 and front trunk 108, for example). Unlocking process part 11a of vehicle control device 10 then sends response demand information of a demand to send identification information to portable device 30 when the passenger turns on starting switch 8a, front trunk open and close switch 8b, seat open and close switch 8c or fuel filling port open and close switch 8d (S102). Response process part 31b of portable device 30 judges whether instruction receive information is stored in storage part 32. The instruction receive information is stored in S101 in the example. Accordingly, response process part 31b sends the identification information of portable device 30 as well as the unlocking limitation instruction information to vehicle control device 10 (S103). Unlocking process part 11a of vehicle control device 10 executes the certification process for portable device 30 on the basis of the identification information received from portable device 30 and also judges whether unlocking limitation instruction information is attached to the identification information. In the example, unlocking limitation instruction information is attached to the identification information. Therefore, unlocking process part 11a outputs no signal for unlocking steering shaft 106, ECU 2, fuel filling port 111a, seat 109, front trunk 108 or the like to actuator driving circuit 17 or 18, solenoid driving circuit 19 or relay driving circuit 16, thereby maintaining a locking condition thereof (S104).

Next, when operation part 36 receives an instruction to turn on flasher 5, remote operation process part 31d of portable device 30 sends remote operation information of this fact to vehicle control device 10 (S105). In this example, remote control process part 31d may send unlocking limitation instruction information together with the remote operation information since instruction receive information is still stored in storage part 32. Remote operation response part 11c outputs a signal giving an instruction to turn on flasher 5 to flasher driving circuit 21 when vehicle control device 10 receives the remote operation information giving an instruction to turn on flasher 5 (S106).

Remote operation process part 31d sends unlocking limitation instruction information together with remote operation information giving an instruction to unlock seat 109 when operation part 36 receives an instruction to unlock seat 109 since, in this example, instruction receive information is still stored in storage part 32 (S107). Remote operation response part 11c of vehicle control device 10, which receives the remote operation information, judges whether unlocking limitation instruction information is attached to the remote operation information. In this example, unlocking limitation instruction information is attached to the remote operation information. Accordingly, no signal for unlocking seat 109 is outputted to actuator driving circuit 17, thereby maintaining a locking condition.

When a signal indicating that the battery remaining quantity is below a predetermined threshold value is inputted from battery remaining quantity observation circuit 35, condition observation process part 31c of portable device 30 sends battery remaining quantity information indicating this fact as well as unlocking limitation instruction information to vehicle control device 10, since instruction receive information is still stored in storage part 32 in this example (S108). Condition observation process part 11b of vehicle control device 10 stores the battery remaining quantity information in storage part 12 because unlocking limitation instruction information is attached to the battery remaining quantity information (S109).

When operation part 36 receives an instruction from the passenger to release the limitation of unlocking a device subject to locking, unlocking limitation process part 31a removes the instruction receive information from storage part 32 (S110). When the passenger then turns on starting switch 8a, front trunk open and close switch 8b, seat open and close switch 8c or fuel filling port open and close switch 8d, unlocking process part 11a of vehicle control device 10 sends response demand information to portable device 30 (S111). Response process part 31b of portable device 30 sends identification information to vehicle control device 10 without attaching unlocking limitation instruction information since the instruction receive information is now removed from storage part 32 (S112). Unlocking process part 11a of vehicle control device 10 executes the certification process for portable device 30 on the basis of the identification information and judges whether unlocking limitation instruction information is attached to the identification information (S113). Since unlocking limitation instruction information is not attached to the identification information in this example, unlocking process part 11a outputs a signal for unlocking steering shaft 106, ECU 2, fuel filling port 111a, seat 109, front trunk 108 or the like to actuator driving circuit 17 or 18, solenoid driving circuit 19 or relay driving circuit 16, to thereby unlock the device subject to locking (S114). On the other hand, condition observation process part 11b reads out battery remaining quantity information from storage part 12 to output a signal giving an instruction to turn on indicator lamp 7a to indicator lamp driving circuit 22 (S115).

In accordance with keyless entry system 1 described above, condition information and remote operation information can be sent and received between portable device 30 and vehicle control device 10 even when a passenger carries out a predetermined button operation to limit unlocking of a device of motorcycle 100 subject to locking, such as ECU 2, steering shaft 106, fuel filling port 111a, seat 109 or front trunk 108. This improves convenience of the keyless entry system.

The invention is not limited to keyless entry system 1 described above. Various kinds modifications are possible. In keyless entry system 1 described above, for example, instruction receive information indicating that a passenger gives an instruction to limit unlocking of a device subject to locking is stored in storage part 32 of portable device 30. The instruction receive information, however, may be stored in storage part 12 of vehicle control device 10. It may be arranged that, when instruction receive information is stored in storage part 12, execution of no certification process for portable device 30 by unlocking process part 11a would limit unlocking of the device subject to locking. In this case, condition information and remote operation information may be sent and received between portable device 30 and vehicle control device 10 regardless of whether instruction receive information is stored in storage part 12.

Further, condition observation process part lib may inform portable device 30 of a condition of motorcycle 100 on the basis of whether instruction receive information is stored in storage part 12 when vehicle control device 10 is arranged so that instruction receive information would be stored in storage part 12. Condition observation process part 11b judges whether instruction receive information is stored in storage part 12 when starting switch 8a is turned on, for example. When instruction receive information is stored,in storage part 12, information indicating that starting switch 8a is turned on is sent to portable device 30 as theft alarm information since there is a possibility that a person other than a proper passenger has turned on starting switch 8a. Portable device 30, which has received the theft alarm information, turns on display part 38 in a predetermined mode. An acoustic device may also be provided in portable device 30 to make an alarm sound.

In the above description, observing whether starting switch 8a or the like is turned on is an example of a process of observing a condition of motorcycle 100 by condition observation process part 11b. The process executed by condition observation process part 11b, however, is not limited to the above. For example, an inclination angle sensor may be mounted to output a signal corresponding to an inclination angle of the vehicle body. In this case, condition observation process part 11b judges whether the vehicle body has fallen down on the basis of a signal inputted from the inclination angle sensor. When the vehicle body is judged to have fallen down, information indicating this fact is sent to portable device 30 as condition information. Portable device 30 judges whether instruction receive information is stored in storage part 32 after receiving the condition information. There is a very strong possibility that a passenger is away from the vehicle body and does not see that the vehicle body has fallen down when instruction receive information is stored. Accordingly, condition observation process part 31c of portable device 30 turns on display part 38 in a predetermined mode for the purpose of informing the passenger that the vehicle body has fallen down. When vehicle control device 10 is arranged so that instruction receive information would be stored in storage part 12, as described above, condition observation process part lib may judge whether instruction receive information is stored in storage part 12 for the purpose of judging whether the vehicle body has fallen down or not. In this case, condition observation process part 11b may send information for giving a notice that the vehicle body has fallen down to portable device 30 as condition information when instruction receive information is stored in storage part 12.

Moreover, in the above description, condition information indicating a condition of motorcycle 100 or portable device 30 and remote operation information for remotely operating motorcycle 100 are sent and received between vehicle control device 10 and portable device 30. Information that is sent or received, however, is not limited to the above. Information related to an external environment of motorcycle 100 may be sent from vehicle control device 10 to portable device 30. A temperature sensor may be provided in the vehicle body, for example, in order to detect the external environment of motorcycle 100. In this case, control part 11 of vehicle control device 10 may detect the temperature of the outside on the basis of a signal inputted from the temperature sensor in accordance with a demand from portable device 30 and send temperature information obtained on the basis of a result of the detection to portable device 30.

While particular embodiments of the invention have been described, it should be understood that these embodiments are exemplary, and not restrictive. Various modifications will be apparent to those of skill in the art and are within the scope of the present invention as set forth in the following claims.

1. A keyless entry system comprising:
a portable device carried by a passenger; and
a vehicle control device for carrying out a certification process for the portable device to lock or unlock a device mounted to a vehicle and subject to locking, on the basis of a result of the certification process, wherein
the portable device includes an input device for receiving an instruction from the passenger and sends instruction information giving an instruction to limit unlocking of the device subject to locking to the vehicle control device in accordance with the instruction received from the passenger by means of the input device, and
the vehicle control device maintains locking of the device subject to locking in the case of receiving the instruction information from the portable device.

2. The keyless entry system according to claim 1, wherein
the portable device sends identification information inherent in the portable device together with the instruction information, and
the vehicle control device carries out the certification process on the basis of the identification information of the portable device.

3. The keyless entry system according to claim 1, wherein
the portable device further includes a storing device for storing instruction receive information indicating that the input device has received an instruction to limit unlocking of the device subject to locking from a passenger,
the vehicle control device sends demand information demanding a response from the portable device, and
the portable device sends the instruction information to the vehicle control device in the case of receiving the demand information from the vehicle control device while the storing device holds the instruction receive information.

4. The keyless entry system according to claim 3, wherein the portable device further includes an information device for informing a passenger that the storing device stores the instruction receive information.

5. The keyless entry system according to claim 1, wherein the portable device sends and receives condition information related to a condition of the portable device or a vehicle to and from the vehicle control device.

6. The keyless entry system according to claim 5, wherein the portable device further includes a battery remaining quantity detection circuit for detecting remaining quantity of a battery used as a driving source of the portable device and sends information related to the battery remaining quantity as the condition information.

7. A vehicle comprising the keyless entry system according to claim 1.

8. A motorcycle comprising the keyless entry system according to claim 1.
